(19) United States
(12) Patent Application Publication
(10) Pub. No.: US 2007/0054068 A1
(43) Pub. Date: Mar. 8, 2007

(54) Component for use in paper manufacture, its preparation and use

(76) Inventors: Tomi Kimpimäki, MASKU (FI); Jouko Kaki, Turku (FI); Hendrik Jan Gerrit Luttikhedde, Raisio (FI)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/556,608

(22) PCT Filed: May 14, 2004
(86) PCT No.: PCT/FI04/00293

§ 371 Date: Nov. 15, 2005

(30) Foreign Application Priority Data
May 16, 2003 (FI) 20030734

(51) Int. Cl. B41M 5/00

(52) U.S. Cl. 428/32.34

(57) ABSTRACT

An easily water-soluble or water-dispersible sizing component, which contains cationized polyvinyl butyral or other equivalent cationized polyvinyl acetal, for the improvement of surface properties of paper or other equivalent web product. Cationized polyvinyl butyral can be prepared by cationizing polyvinyl butyral or by butyrating cationized polyvinyl alcohol. The sizing component typically contains 50-90% polyvinyl butyral or other corresponding polyvinyl acetal, and 10-50% of a softener, such as castor oil. The polyvinyl butyral containing sizing component can be used for example in the surface sizing of base paper of release paper and of inkjet paper or in the formation of a barrier layer on the paper surface.

The present invention is directed to a sizing component and surface size in accordance with the preamble parts of the below presented independent claims, and to their use.

The properties of paper surface, such as porosity, hydrophobicity, smoothness, surface strength and linting, and thus also paper coatability and printability, can be affected by surface sizing. The purpose of surface sizing is usually to prepare paper suitable for further treatment.

Conventional surface size compositions, so-called surface sizes, are usually based on starch and are water-soluble. Starch may be native starch, degraded and/or chemically modified starch. Size compositions may in addition to starch or solely contain also other water-soluble sizing components, such as carboxy methyl cellulose (CMC), polyvinyl alcohol, glucomannan or water-soluble proteins. Also synthetic polymers, such as latexes based on styrene butadiene, acrylate or vinyl acetate, can be used.

Often a surface size contains substances, such as hydrophobic agents and salts, which provide the surface size and/or the surface-sized paper with the desired specific properties. A surface size may also contain mineral material, that is pigment, such as talc, kaolin, calcium carbonate, calcium sulphate, titanium dioxide or substance derived from polystyrene. If necessary, a surface size contains also a dispersant, emulsifier, antifoaming agent and stabilizer, rheology regulator, pH regulator and other corresponding agents, the purpose of which is to keep e.g. the structure; composition and other properties of the surface size as desired.

The dry matter content of a conventional surface size is usually in the range of 2-22%, whereby the flow properties of the size have been found suitable for application at a sizing unit. In special cases, for example in surface sizes which contain plenty of pigment, the dry matter content may be remarkably higher, even 30%. The applied quantity is typically in the range of 0.5-3 g/m², at least on one side of the paper. However, the size quantities may be smaller or even remarkably higher, depending on the given specific target of use.

A self-adhesive product is formed of the actual sticker or sticking paper which is provided with an adhesive surface, and of release paper or backlayer, at least one side of which is provided with a release property giving surface, such as a surface coated with a silicone or plastic-based substance. In a self-adhesive product the actual sticker and the release paper have been adjusted against each other so that their adhesive and silicone surfaces touch, whereby the actual sticker is easily releasable from the background.

Several properties, i.a. surface strength and dimensional stability, are required from the release paper in order to secure the run of paper in a coating process, where the release paper is coated with silicone, and in the process where the actual sticker is affixed to the release paper. In order to achieve good siliconization, the surface of base paper of the release paper to be coated has to be smooth and its barrier properties have to be suitable. The absorption of liquids, such as water or oil, into the release paper has to be steady and controlled. Earlier, the pulp composition, calendering, surface sizing or other corresponding means have been used to achieve the desired, rather dense base paper.

In US patent publication U.S. Pat. No. 4,609,589 it has for example been proposed the formation of a base or a separate intermediate layer to the release paper between the base paper and the actual coating, that is a silicone layer. The intermediate layer has been formed from the mixture of soap-free acryl resin emulsion and oxidized starch. The intermediate layer may additionally contain melamine formaldehyde resin.

Respectively, in the international publication WO 01/55507 it has been proposed surface sizing of the base paper of release paper with a surface size which contains binder and pigment. The binder has been formed from the mixture of polyvinyl alcohol and latex dispersion. The binder may additionally contain CMC. The pigment is preferably talc.

In US patent publication U.S. Pat. No. 4,859,511 it has also been proposed to form a separate intermediate layer between the base paper and the coating of release paper, which layer comprises a component selected from the group containing i.a. polybutadiene, polyisoprene, alkyl ketene dimer, alkenyl succinic acid anhydride, styrene butadiene, styrene isoprene, styrene ethylene polymers and polybutadiene acrylate.

However, release papers and their preparation processes are faced with problems. In the surface size it may be necessary to use so high amounts of a water-soluble binder, such as starch, that it may lead to linting, which in turn easily causes runnability problems and weakening of the quality. Poor surface sizing of base paper may lead to too high absorption of silicone into paper, whereby the consumption of silicone and the catalyst used for siliconization is unnecessarily high. Further, silicone may absorb into the paper unevenly, whereby the maturing of silicone may become uneven and the result is an uneven release property. If the desired even, stable and strong silicone surface cannot be achieved, also the final quality of the self-adhesive product suffers.

Special properties are also required from paper intended for inkjet printers, that is inkjet paper. The ink has to be absorbed to the paper surface quickly and in an appropriate amount and it has to dry almost immediately. The ink has thus to penetrate deep enough into the paper surface but not too deep, however. In addition, the ink must not spread too much in order to achieve a good printing trace. Good properties may be difficult to achieve.

In US patent publication U.S. Pat. No. 6,146,770 it has been proposed to coat inkjet paper with two coating layers, with an ink absorbing layer and a layer which covers said ink-absorbing layer and provides moisture protection. The ink-absorbing layer has been formed from a mixture which contains poly(2-ethyl-2-oxazoline), polyvinyl pyrrolidone and a hydrophobic polymer. The moisture protective layer has been formed from a mixture of polyethylene oxide and aluminium oxide and hydroxide.

In the international patent application publication WO 02/072361 it is proposed to coat inkjet paper with a mixture, which contains mineral material and a polymeric binder. The polymeric binder is a polyvinyl alcohol provided with a primary amine.

From European patent application publication EP 1 088 856 A1 it is known to use a mixture of gelatine and partly acetalized polyvinyl alcohol for coating of inkjet paper. Polyvinyl alcohol is acetalized for example with sulfonic acid groups, sulfobenzaldehyde or aminobenzaldehyde.

From European patent application publication EP 0 834 520 A2 it is known to use as a coating of paper or textiles or as a binder of colours or lacquers a water dispersion of polyvinyl acetal which contains carboxyl groups.

The purpose of the present invention is to achieve an improvement to the above disclosed problems.

The purpose of the present invention is thus to provide a sizing component, a surface size and a product treated with the sizing component, which are improved compared to the above mentioned products.

In particular, the purpose is to achieve an improved sizing component and a surface size, whereby remarkable quality and cost advantages in the preparation of release paper can be achieved.

The purpose is for example to achieve an improved sizing component and a surface size, with the help of which the need of silicone and a catalyst in the siliconization of release paper is minimized.

The purpose is also to achieve an improved sizing component and a surface size, which provide remarkable quality and cost advantages in the preparation of ink jet paper.

In order to achieve the above mentioned purposes, the adhesive component, surface size, release paper, inkjet paper, and barrier-coated paper according to the invention are known from what is disclosed in the characterizing parts of the below presented independent claims.

It has now been found that with a sizing component based on water-soluble or water-dispersible polyvinyl butyral or on other corresponding polyvinyl acetal the above mentioned improvements and advantages can be achieved, compared to prior sizing components used in surface sizing. Polyvinyl butyral is typically prepared by butyration of polyvinyl alcohol.

A polyvinyl acetal based, typically polyvinyl butyral based, sizing component can according to the method proposed by the invention be formed as to its composition so that it is easily water-soluble or easily water-dispersible and thus usable as a surface size or as part of the surface size. A water-soluble or easily water-dispersible polyvinyl butyral based sizing component can in a simple manner be used as such in the surface sizing of paper or it can easily be used together with other water-soluble or water-dispersible surface sizes, such as starch-based surface sizes.

Within this application, polyvinyl butyral or other polyvinyl acetal means a product prepared from polyvinyl alcohol, in which at least part of the hydroxyl groups of polyvinyl alcohol have been butyrated or otherwise acetalized.

It has now been found that polyvinyl butyral or other corresponding polyvinyl acetal is obtained in water-soluble form or easily water-dispersible form, when only part of the hydroxyl groups of polymer are butyrated or otherwise acetalized. Water-solubility may be controlled for example

by adjusting the amount of butanal used for butyration to be relatively small,

by cationizing part of the hydroxyl groups of the polymer to be formed, before butyration, or

by cationizing the polymer after butyration.

On the other hand, water-solubility and dispersability can also be affected by using a suitable polyvinyl butyral softener, such as castor oil or alkyl ricinoleate, for example butyl ricinoleate.

Polyvinyl butyral is typically prepared by butyrating polyvinyl alcohol with butanal in the presence of a suitable catalyst. Preferably an acid catalyst, such as HCl, H2SO4, H3PO4 or paratoluene sulphonic acid, or an acidic cation exchange resin, can be used as a catalyst.

By controlling the amount of butanal, the water-solubility of the polyvinyl butyral to be formed can be adjusted. If the amount of butanal is maintained very small, 5-15% of the stoichiometric amount, water-soluble polyvinyl butyral is obtained. If butanal is added in an amount of over 15%, unsoluble polyvinyl butyral, that is slurryish or powderlike polyvinyl butyral product, starts to form.

The unsoluble polyvinyl butyral becomes more water-soluble for example by cationizing. Cationized polyvinyl butyral is typically prepared either

by cationizing polyvinyl alcohol before the actual butyration reaction or
by cationizing the final polyvinyl butyral after butyration reaction.

As a cationizing chemical, for example 2,3-epoxypropyl trimethyl ammonium chloride or an equivalent chlorohydrine-functional cationizing agent can be used. The cationization degree of a water-soluble polyvinyl butyral prepared by cationization is then usually 5-80%, typically 20-50%. Butyration degree can thus be 20-95%, typically 50-80%.

A typical cationized, water-soluble polyvinyl butyral comprises thus usually also unbutyrated hydroxyl groups, whereby the formed polymer typically comprises
hydroxyl groups 2-50%, typically 10-30%,
butyral groups 5-50%, typically 20-35%, and
cationic groups 5-80%, typically 30-50%, and
possibly some acetate groups, typically 2-12%.

On the other hand, unsoluble polyvinyl butyral may be converted in water-soluble or water-dispersible form not only by cationizing but also by using a suitable softener, such as castor oil or alkyl ricinoleate and optionally an emulsifier at a suitable temperature.

According to a preferred embodiment of the invention, polyvinyl butyral or other corresponding polyvinyl acetal can be made water-soluble or easily water-dispersible by a softener in a mixture, which contains

50-90% polyvinyl butyral or other corresponding polyvinyl acetal, and

10-50% of a softener, such as castor oil and/or another ester derived therefrom, such as for example butylricinoleate.

To a sizing component prepared from water-soluble or water-dispersible polyvinyl butyral or other corresponding polyvinyl acetal can, if needed, be added some anionic emulsifier, usually however in an amount of at most 6%. As an emulsifier can be used potassium oleate, alkyl sulphate, alkyl aryl sulphonate, lignosulphonate or other sulphonates, and/or sulphosuccinates and/or some nonionic emulsifier, such as fatty alcohol ethoxylate.

In addition, a stabilizer may, if needed, be added in the sizing component, generally however in an amount of at most 8%, typically below 5%. As stabilizers for example polypropylene oxide and/or polyethylene oxide, and optionally one or several hydrophobic components for example from the group which contains alkylene succinic acid (ASA) and aldehydes or ketones with a carbon chain length which is longer than for butanal (C4), may be used.

The surface size may in addition to the sizing component contain other conventional surface size components such as for example

water-soluble binder, such as starch, CMC, glucomannan, polyvinyl alcohol, and casein or other protein-based binder,

mineral material, such as kaolin, talc, calcium carbonate, calcium sulphate or titanium dioxide,

synthetic polymer, such as styrene butadiene, acrylate or vinyl acetate latex,

antifoaming agent,

hardening agent, or

their mixture.

A typical surface size according to the invention contains at least

a water-soluble or easily water-dispersible polyvinyl butyral based sizing component 5-40%, preferably 15-35%, typically 20-30%,

polyvinyl alcohol component 10-70%, preferably 15-35%, typically 20-30%, and

mineral component 0-80%, preferably 30-70%, typically 40-60%, calculated as dry matter.

In order to achieve good solubility or dispersability, the polyvinyl butyral used may be cationic, the cationization degree being 5-80%, typically 20-50%. Butyration degree may then be 95-20%, typically 80-50%.

In order to achieve good solubility or dispersability, one can alternatively or in addition to the above mentioned cationic polyvinyl butyral use a polyvinyl butyral with a low butyration degree, typically 5-15%, which has not been cationized or which has been cationized substantially less than described above.

On the other hand, to the surface size may alternatively or in addition to the above mentioned polyvinyl butyrals be added slurryish or powderlike polyvinyl butyral dispersed with a softener, such as castor oil or other corresponding softener. The polyvinyl butyral dispersed with the aid of a softener typically contains
polyvinyl butyral 50-90% and
a softener, such as castor oil, 10-50%.

The sizing component according to the invention, which contains water-soluble or easily water-dispersible polyvinyl butyral or other polyvinyl acetal, can advantageously be used in liquid or dispersion form as such or mixed with a surface size for the improvement of surface properties, such as porosity, smoothness, or inhibition of liquid absorption, of for example release paper or other corresponding paper.

The sizing component or surface size according to the invention may thus be used for example in surface sizing of the base paper of release paper, before coating the release paper with a silicone layer or other corresponding release layer, such as a plastic layer.

The surface size or sizing component according to the invention which contains polyvinyl butyral can advantageously be used also in the treatment of the surface of inkjet paper or other paper provided with a layer having a low liquid absorption.

Surface size is spread on the surface of the base paper usually in the amount of 0.5-3.5 g/m2.

The sizing component according to the invention which contains polyvinyl butyral can be used to form a barrier layer on the surface of paper, when it is desired to control, usually to decrease, the absorption of water, water vapour or oil into the paper. The barrier layer is then typically 4-8 g/m² or even higher, in order to cover the fibre layer.

It has been found that the barrier layer according to the invention provides the paper with high smoothness, low porosity and low absorption of water, water vapour and oil. The treatment of the base paper with a sizing component according to the invention enables an even coating of the paper or other additional treatment to proceed as desired. The barrier layer does not have an adverse effect on the siliconization of the paper or on the maturing of silicone. On the contrary, this enables to secure a smooth siliconization of release paper and a constant maturing of silicone.

In the tests made in laboratory scale it has been possible to prove that the polyvinyl butyral based sizing component according to the invention works extremely well.

In the following examples, the preparation of four alternative sizing components according to the invention is disclosed.

### EXAMPLE 1

33.3 g polyvinyl alcohol (PVA) was dissolved in 100 grams of water. To this solution was added 57 g 2,3-epoxypropyltrimethyl ammonium chloride to cationize the PVA. The mixture was stirred and heated at 80° C. and to the mixture was added 2 g NaOH (50%). Reaction time was 4.5 hours.

Then the pH of the mixture was lowered with sulfuric acid to the level pH 1,5, and to the mixture was added an emulsifier in an amount of 3% of the amount of the PVA and butanal in an amount of 10% of the amount of the PVA in order to butyrate the cationized PVA. Reaction time was first 12 hours at 25° C. and then 4 hours at 60° C. As a result was obtained a sizing component solution containing cationic polyvinyl butyral.

### EXAMPLE 2

33.3 g polyvinyl alcohol (PVA) was dissolved in 100 grams of water. To this solution was added 57 g 2,3-epoxypropyltrimethyl ammonium chloride to cationize the PVA. The mixture was stirred and heated at 80° C. and to the mixture was added 2 g NaOH (50%). Reaction time was 4.5 hours.

Then the pH of the mixture was lowered with sulfuric acid to the level pH 1.5 and to the mixture was added an emulsifier in an amount of 3% of the amount of the PVA and butanal in an amount of 35% of the amount of PVA, in order to butyrate the cationized PVA. Reaction time was first 12 hours at 25° C. and then 4 hours at 60° C. As a result was obtained a sizing component dispersion containing cationic polyvinyl butyral.

### EXAMPLE 3

33.3 g polyvinyl alcohol (PVA) was dissolved in 77 grams of water. To this solution was added 57 g 2,3-epoxypropyltrimethyl ammonium chloride to cationize the PVA. The mixture was stirred and heated at 80° C. and to the mixture was added 2 g NaOH (50%). Reaction time was 4.5 hours.

Then the pH of the mixture was lowered with sulfuric acid to the level pH 1.5 and to the mixture was added an emulsifier in an amount of 3% of the amount of the PVA and butanal in an amount of 50% of the amount of PVA, in order to butyrate the cationized PVA. Also 33.3 g of castor oil were added to the mixture. Reaction time was first 12 hours at 25° C. and then 4 hours at 60° C. As a result an even more easily dispersible sizing component dispersion containing polyvinyl butyral was obtained.

### EXAMPLE 4

40 g of ready-made polyvinyl butyral (PVB) was slurried in 60 grams of water. 25 g of 2,3-epoxypropyltrimethyl ammonium chloride and 20 g NaOH (50%) were added to cationize 10 the PVB. The mixture was stirred and heated for 5 hours at 80° C. Thereafter the mixture was neutralized with sulfuric acid and an emulsifier was added in an amount of 3% of the amount of the PVB and then the mixture was homogenized. As a result, a sizing component dispersion which contains cationic polyvinyl butyral, was obtained.

The test results of the comparison of the properties of paper surfaces coated with different polyvinyl butyral containing surface sizes and with reference surface sizes, are presented in the following.

Fine paper (70 g/m2) was coated in the tests. The coating amount was 2.5 g/n2. The coating was allowed to dry. Then the following properties of the coated paper surface were examined: elasticity, smoothness/porosity and the absorption of both water and oil into the surface.

Test 1

The surface sizes contain kaolin. A sizing component containing polyvinyl butyral and castor oil according to the invention, has been added to the surface sizes 1-3 in a mixing ratio of 1.5:1.

| | Reference 1 | Size 1 | Size 2 | Size 3 |
|---|---|---|---|---|
| Components | | | | |
| of surface size | | | | |
| kaolin | 50 | 50 | 50 | 57 |
| PVA | 30 | 15 | 25 | 25 |
| CMC | 5 | — | — | 5 |
| starch | 10 | 10 | — | — |
| PVB + castor oil | — | 20 | 10 | 5 |
| SB-latex | — | — | — | 5 |
| acrylate latex | — | — | 15 | — |
| hardening agent | 5 | 5 | — | 3 |
| antifoaming agent | 0.1 | 0.1 | — | 0.1 |
| Results | | | | |
| elasticity | * | *** | ** | ** |
| smoothness/porosity | ** | ** | ** | *** |
| water absorption | * | ** | *** | * |
| oil absorption | * | ** | ** | ** |

* = moderate
** = good/small absorption
*** = excellent/very small absorption

The results show that the partial replacement of PVA, CMC or starch used in the surface size of Reference 1 by a sizing component dispersion containing polyvinyl butyral and castor oil has an extremely good effect on the above mentioned surface properties of paper.

Test 2

The surface sizes do not contain kaolin. A sizing component containing polyvinyl butyral and castor oil according to the invention has been added to the surface sizes 4 and 5 in a mixing ratio of 1.5:1.

| | Reference 2 | Size 4 | Size 5 |
|---|---|---|---|
| Components of | | | |
| surface size: | | | |
| PVA | 69 | 65 | 30 |
| CMC | 10 | 5 | 5 |
| starch | 14 | — | 30 |
| PVB + castor oil | — | 25 | 30 |
| hardening agent | 7 | 5 | 5 |
| Results | | | |
| elasticity | * | *** | *** |
| smoothnesss/porosity | * | ** | ** |
| water absorption | * | ** | ** |
| oil absorption | ** | *** | *** |

* = moderate
** = good/small absorption
*** = excellent/very small absorption

The results show that the partial replacement of PVA, CMC or starch used in the surface size of Reference 2 by a sizing component dispersion containing polyvinyl butyral and castor oil has an even better effect on the surface properties of paper, when the surface size does not contain kaolin.

Test 3

A sizing component of Example 2, which according to the invention contains cationic polyvinyl butyral, has been added to the surface sizes 6-7.

| | Size 6 | Size 7 |
|---|---|---|
| Components of | | |
| surface size | | |
| kaolin | 20 | — |
| PVA | 55 | 55 |
| CMC | — | 5 |
| starch | 5 | 20 |
| cationic PVB | 15 | 15 |
| hardening agent | 5 | 5 |
| antifoaming agent | 0.2 | — |
| Results | | |
| elasticity | *** | *** |
| smoothness/porosity | ** | ** |
| water absorption | * | * |
| oil absorption | ** | *** |

* = moderate
** = good/small absorption
*** = excellent/very small absorption

The results show that also a sizing component containing cationic polyvinyl butyral has an advantageous effect on paper coating properties.

In the above the invention has been explained by way of examples. However, the purpose is to apply the invention widely within the scopes of the below presented independent claims. The invention is thus intended for use for example not only in connection with paper manufacture but also in connection with the preparation of other corresponding web products, such as in connection with the preparation of paperboard.

1. A sizing component for the improvement of surface properties of paper or other corresponding fibre-based web product, characterized in that the sizing component contains polyvinyl butyral prepared from polyvinyl alcohol by butyration, or other polyvinyl acetal prepared by acetalization, which is water-soluble and/or easily water-dispersible.

2. The sizing component according to claim 1, characterized in that the sizing component contains cationized polyvinyl butyral, which has been prepared
by cationizing polyvinyl butyral or
by butyrating cationized polyvinyl alcohol.

3. The sizing component according to claim 1, characterized in that the sizing component contains cationized polyvinyl butyral with
a cationization degree of 5-80%.

4. The sizing component according to claim 1, characterized in that the sizing component contains cationized polyvinyl butyral, which contains
hydroxyl groups 2-50%,
butyral groups 5-50%, and
cationic groups 5-80%.

5. The sizing component according to claim 1, characterized in that the sizing component contains polyvinyl butyral having 5-15% butyral groups.

6. The sizing component according to claim 1, characterized in that the sizing component contains
50-90% polyvinyl butyral or other corresponding polyvinyl acetal and
10-50% softener.

7. A process for the preparation of polyvinyl butyral included in the sizing component according to claim 1, characterized in that the polyvinyl butyral is prepared
by cationizing polyvinyl alcohol and then by butyrating the thus obtained cationic polyvinyl alcohol, or
by butyrating polyvinyl alcohol and then by cationizing the thus obtained polyvinyl butyral.

8. The process according to claim 7, characterized in that 2,3-epoxypropyltrimethyl ammonium chloride or an equivalent chlorohydrine-functional cationizing agent is used as a cationizing chemical.

9. A process for preparing the polyvinyl butyral included in the sizing component according to claim 1, characterized in that a polyvinyl butyral solution or dispersion is prepared by butyrating polyvinyl alcohol with butanal in the presence of an acid catalyst and by adding butanal to polyvinyl alcohol in an amount of 5-15% of the stoichiometric amount.

10. A process for preparing the polyvinyl butyral included in the sizing component according to claim 1, characterized in that
polyvinyl butyral slurry or powder is prepared by butyrating polyvinyl alcohol with butanal in the presence of an acid catalyst and by adding thereby butanal to polyvinyl alcohol in an amount which is >15% of the stoichiometric amount, and
by dispersing the obtained polyvinyl butyral slurry or powder with the help of castor oil or other corresponding softener in order to prepare polyvinyl butyral dispersion.

11. (canceled)

12. A surface size for improvement of surface properties of paper, characterized in that the surface size contains at least
water-soluble or easily water-dispersible polyvinyl butyral based sizing component 5-40%,
polyvinyl alcohol component 10-70%,
mineral component, such as talc, kaolin, calcium carbonate, calcium sulphate, or titanium dioxide, 0-80%.

13. The surface size according to claim 12, characterized in that the polyvinyl butyral included in the surface size is cationic polyvinyl butyral, which comprises
hydroxyl groups 2-50%,
butyral groups 5-50%, and
cationic groups 5-80%.

14. The surface size according to claim 12, characterized in that the polyvinyl butyral based sizing component contains
polyvinyl butyral 50-90% and
softener, 10-50%.

15. The surface size according to claim 12, characterized in that the butyration degree of polyvinyl butyral is 5-15%.

16. The surface size according to claim 12, characterized in that it further comprises
water-soluble binder,
synthetic polymer,
or their mixture.

17. A method of improving the surface properties, of release paper, inkjet paper or other corresponding paper by spreading the surface size according to claim 12 on at least one side of the paper.

18. A method of improving the surface properties of paper, characterized in that the surface size according to claim 12 is spread-on at least one side of the paper in an amount of 0.5-3.5 g/m².

19. A method of forming a release paper by coating said paper with sizing component, which contains polyvinyl butyral, before coating of the release paper with a release layer.

20. A method of forming a printing paper for inkjet printer by spreading a sizing component which contains polyvinyl butyral, onto said paper.

21. Release paper which has been coated with a release substance, characterized in that the base paper of the release paper has, before coating with a release substance, been treated with a sizing component or surface size that contains polyvinyl butyral.

22. Printing paper for inkjet printer or other equivalent paper, characterized in that the paper surface has been treated with a sizing component or surface size that contains polyvinyl butyral.

23. Barrier-coated paper, characterized in that the paper surface has been treated with a sizing component or surface size which contains polyvinyl butyral, in order to form a barrier layer to the surface.

24. The sizing component according to claim 6, wherein the softener is castor oil and/or an ester derived therefrom.

25. The surface size according to claim 14, wherein the softener is castor oil.

26. The surface size according to claim 16, wherein the synthetic polymer is styrenebutadiene, acrylate or vinyl acetate based latex.

27. The surface size according to claim 16, wherein the water-soluble binder is starch, carboxymethylcellulose, glucomannan, polyvinyl alcohol, casein or other protein based binder.
